(19) United States
(12) Patent Application Publication
(10) Pub. No.: US 2016/0005249 A1
(43) Pub. Date: Jan. 7, 2016

(54) SYSTEMS, DEVICES, AND METHODS FOR MANAGING COMMODITIES

(71) Applicant: Active Tools International (HK) Ltd., Hong Kong (CN)

(72) Inventor: David Ying Chi Hong, Hong Kong (CN)

(21) Appl. No.: 14/323,210

(22) Filed: Jul. 3, 2014

(51) Int. Cl. G07C 9/00

(52) U.S. Cl. CPC G07C 9/00166

(57) ABSTRACT

Provided are systems, articles of manufacture, methods, and computer program products for managing a commodity, such as, for example, a vehicle accessory. Methods may include receiving an activation input for a commodity and, responsive to receiving the activation input, generating information relating to the activation input for the commodity.

### BACKGROUND

Many commodities are used and/or rented by consumers. For example, various vehicle accessories, such as a spare tire and/or GPS system, can be rented by a consumer or are available in a rented car for the consumer's use, if needed. In the recent decade, tire repair kits (TRKs) have been developed to replace an on-board spare tire as the spare tire takes up valuable trunk space, adds weight, and reduces fuel economy. TRKs provide an easy solution for repairing a tire puncture temporarily. Since TRKs can allow a driver to repair and inflate their flat tire in less than 10 minutes, it may be a safer solution compared to spare tires.

While there are advantages to providing consumers with access to such commodities, retailers (e.g., rental business operators, delivery companies, etc.) face challenges in managing these items. Taking TRKs as an example, an average of ten TRKs are stolen per week out of cars in rental car facilities at airports (e.g., Los Angeles International Airport goes through an average of 14 TRKs per week because of theft for one car rental agency alone). Tracking the usage of commodities, such as TRKs, can be difficult and time consuming.

### BRIEF SUMMARY

It is noted that aspects described with respect to one embodiment may be incorporated in different embodiments although not specifically described relative thereto. That is, all embodiments and/or features of any embodiments can be combined in any way and/or combination. Moreover, other systems, articles of manufacture, methods, and/or computer program products according to embodiments will be or become apparent to one with skill in the art upon review of the following drawings and detailed description. It is intended that all such additional systems, articles of manufacture, methods, and/or computer program products be included within this description, be within the scope of the present inventive concept, and be protected by the accompanying claims.

Some embodiments are directed to systems, articles of manufacture, methods and/or computer program products for managing a commodity, such as, for example, a vehicle accessory. In some embodiments, operations include receiving an activation input for a commodity and, responsive to receiving the activation input, generating information relating to the activation input for the commodity.

In some embodiments, receiving the activation input corresponds to a request for access to the commodity by a user and, responsive to receiving the activation input for the commodity, providing the user access to the commodity. Some embodiments provide, responsive to receiving the activation input for the commodity, validating the activation input to determine authorized access to the commodity and, responsive to validating the activation input, providing the user access to the commodity.

Some embodiments include storing the information relating to the activation input for the commodity to preserve the information for subsequent access and/or use. Some embodiments include transmitting the information relating to the activation input for the commodity to track access to the commodity.

Some embodiments include receiving the activation input for the commodity at an access control component of the commodity and/or generating the information relating to the activation input for the commodity at the access control component of the commodity. In some embodiments, the access control component includes a locking component configured to prevent unauthorized access to the commodity, and receiving the activation input for the commodity includes receiving a message that an unlocking component configured to unlock the locking component is being and/or has been used at the locking component.

In some embodiments, the access control component includes a container that stores the commodity. Some embodiments include detecting access to the commodity using a sensor configured to detect access to the commodity in the container.

Some embodiments include logging the information generated relating to the activation input for the commodity in a logging module in the access control component. In some embodiments, receiving the activation input for the commodity includes receiving, at a locking component included in the access control component, a message that an unlocking component configured to unlock the locking component is being and/or has been used at the locking component and, responsive to receiving the message, generating the information relating to the activation input for the commodity at the logging module. In some embodiments, receiving the activation input for the commodity includes detecting, at a sensor included in the access control component, access to the commodity and, responsive to detecting the access, generating the information relating to the activation input for the commodity at the logging module.

In some embodiments, receiving the activation input for the commodity and/or generating the information relating to the activation input for the commodity includes receiving at a server the activation input for the commodity and/or generating at the server the information relating to the activation input for the commodity. Some embodiments include receiving at the server a request for access to the commodity from a user and, responsive to receiving the activation input, generating at the server the information relating to the activation input for the commodity and providing the user access to the commodity.

In some embodiments, receiving the activation input for the commodity includes receiving at an electronic device a code configured to demonstrate access to the commodity and the code is configured to demonstrate access to a passcode for accessing the commodity.

Some embodiments include accessing the information relating to the activation input for the commodity and, responsive to accessing the information relating to the activation input for the commodity, inspecting the commodity.

In some embodiments, a commodity is provided, such as a removable commodity. The commodity includes an access control component configured to prevent unauthorized access to the commodity and to provide access to the commodity to an authorized user. Some embodiments include a communication module configured to send and/or receive information relating to an activation input for the commodity that, upon receipt thereof, causes the access control component to provide access to the commodity to the authorized user.

Some embodiments are directed to a server. The server includes a processor configured to generate information relating an activation input for a commodity, a communication module configured to receive an activation input for a commodity and to transmit the information relating to an activation input for the commodity, and a memory configured to store computer related instructions that, when executed, cause the processor to generate the information relating to the activation input for the commodity and to store the information.

In some embodiments, an electronic device is provided. The electronic device includes a processor configured to generate information relating to an activation input for a commodity, the processor including a scanner, wherein the scanner is configured to detect the activation input for the commodity. In some embodiments, the electronic device includes a communication module configured to transmit the information relating to the activation input for the removable commodity, and a memory configured to store computer related instructions that, when executed, cause the processor to generate the information relating to the activation input for the commodity and to store the information. Some embodiments include a user interface to display on the electronic device at least a portion of the information relating to the activation input for the commodity and/or an indication that the information relating to the activation input for the commodity was generated.

Some embodiments of the present disclosure are directed to computer program products that include a computer readable storage medium having computer readable program code embodied in the medium. The computer code may include computer readable code to perform operations as described herein.

Some embodiments of the present disclosure are directed to a computer system that includes at least one processor and at least one memory coupled to the processor. The at least one memory may include computer readable program code embodied therein that, when executed by the at least one processor causes the at least one processor to perform operations as described herein.

It is noted that aspects of the disclosure described with respect to one embodiment, may be incorporated in a different embodiment although not specifically described relative thereto. That is, all embodiments and/or features of any embodiment can be combined in any way and/or combination. These and other objects and/or aspects of the present inventive concept are explained in detail in the specification set forth below.

### BRIEF DESCRIPTION OF THE DRAWINGS

Aspects of the present disclosure are illustrated by way of example and are not limited by the accompanying figures with like references indicating like elements.

FIG. 1 is a flowchart illustrating operations of a method according to some embodiments of the present inventive subject matter.

FIG. 2 is a flowchart illustrating operations of a party receiving information according to some embodiments of the present inventive subject matter.

FIG. 3 is a block diagram illustrating a system according to some embodiments of the present inventive subject matter.

FIG. 4 is a schematic diagram illustrating a wireless communications system according to some embodiments of the present inventive subject matter.

FIG. 5 is a block diagram illustrating a server according to some embodiments of the present inventive subject matter.

FIG. 6 is a block diagram illustrating an electronic device according to some embodiments of the present inventive subject matter.

FIG. 7 is a flowchart illustrating operations in managing a commodity according to some embodiments of the present inventive subject matter.

### DETAILED DESCRIPTION

As discussed herein, a system, article of manufacture, method, and/or computer program product of the present inventive subject matter may provide an effective and efficient way to manage a commodity. For example, a system, article of manufacture, method, and/or computer program product of the present inventive subject matter may provide a retailer with a way to determine if a commodity is available for a consumer (e.g., if a car is equipped with an accessory) and/or if the commodity is in condition for use. In some embodiments, a system, article of manufacture, method, and/or computer program product of the present inventive subject matter may provide a retailer with a way to recover costs associated with a commodity, such as, for example, if the commodity is used, lost, stolen, and/or damaged (e.g., by passing the costs onto a user, such as a customer or employee).

The commodity in some embodiments may be a removable commodity, such as an onboard removable commodity (e.g., a commodity available on a plane, bus, van, etc.). Exemplary commodities include, but are not limited to, vehicle accessories such as, for example, a tire repair kit, a spare tire, and/or a GPS system; an electronic device charger (e.g. a phone charger, tablet charger, computer charger, etc.); a first aid kit; a lock; a safety device (e.g., a helmet, life vest, etc.); and/or the like.

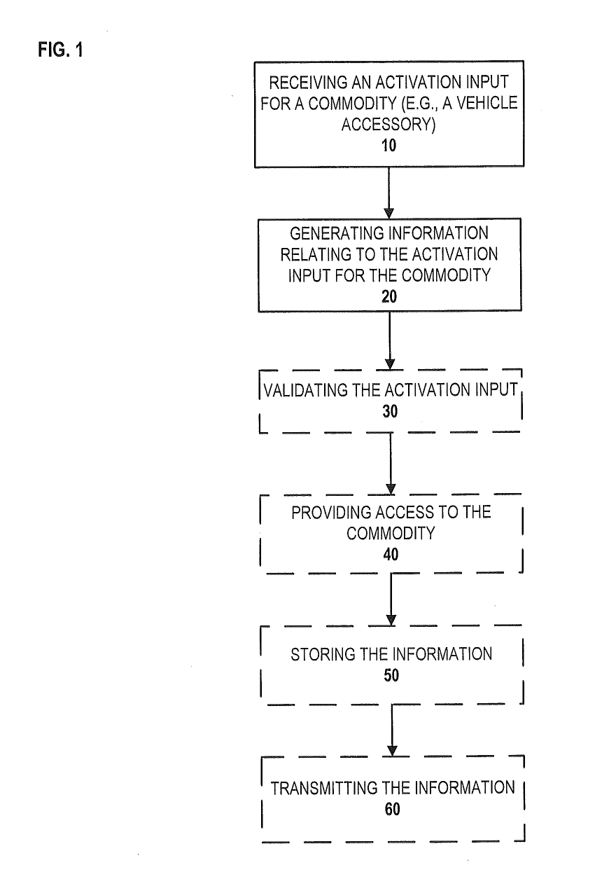

Reference is now made to FIG. 1, which is a flowchart illustrating operations of a method according to some embodiments of the present inventive subject matter. The method may include receiving an activation input for a commodity at block 10 and, responsive to receiving the activation input, generating information relating to the activation input for the commodity at block 20.

The information generated relating to the activation input for the commodity at block 20 may be generated simultaneously with receiving the activation input and/or may be generated after the activation input is received. The information generated relating to the activation input for the commodity at block 20 may include an identification for the commodity (e.g., a unique identification such as a number or code associated with the particular commodity), the date and/or time the activation input was received and/or the commodity was accessed, and/or an indication as to whether the commodity was accessed (e.g., a confirmation message that the commodity was accessed). The information generated relating to the activation input for the commodity at block 20 may be generated in any manner, such as, for example, the information may be physically and/or electronically generated. In some embodiments, the information generated relating to the activation input for the commodity at block 20 may be generated as data in a memory and/or may be generated as a data stream that includes the information. In some embodiments, the information generated relating to the activation input for the commodity at block 20 may be generated as a persistent condition at the device, such as, for example, a seal and/or scratch off to indicate access and/or attempted access.

“Activation input” as used herein may include a request for access to a commodity, which request may be made by a user. In some embodiments, the request for access may comprise a user requesting a passcode and/or activation of a passcode for accessing the commodity. In some embodiments, the request for access may comprise a user requesting that a commodity be made accessible by the receiving party (e.g., a third party and/or retailer such as a rental company or delivery company), which may have remote control over access to the commodity. The user may be a customer or an employee of a retailer, such as a rental company or a delivery company. An “activation input” may also include use of an unlocking component, such as, but not limited to, a key, IC card, magnetic stripe card, proximity card, passcode and/or the like, to request access and/or obtain access to the commodity. “Activation input” may further include opening and/or accessing a container associated with the commodity. In some embodiments, an “activation input” may include identifying and/or detecting a request for access to a commodity, such as, for example, by identifying and/or detecting a code configured to demonstrate access to the access and/or the obtainment of a passcode enabling access to the commodity. For example, an activation input may include identifying and/or detecting that a concealed passcode section has been accessed, such as by removing (e.g., by tearing or scratching off) the concealment to obtain a passcode for accessing a commodity.

In some embodiments, receiving an activation input for a commodity at block 10 may include receiving a request from a user for access to a commodity. The user may request a passcode and/or activation of a passcode for accessing the commodity and/or the user may request that the commodity be made accessible by the receiving party (e.g., a third party and/or a retailer). The user may make the request by calling a dedicated phone number and/or by using a mobile device application. In some embodiments, the receiving party may have remote control over access to the commodity and may activate and/or provide access to the commodity remotely. Responsive to receiving the activation input for the commodity at block 10, the information relating to the activation input may be generated at block 20, such as, for example, at a server.

In some embodiments, receiving an activation input for a commodity at block 10 may include receiving an unlocking component configured to request access and/or obtain access to the commodity. For example, receiving an activation input for a commodity may include receiving a message that an unlocking component is and/or was used to unlock a locking component configured to prevent unauthorized access to the commodity, thereby providing access to a commodity.

In some embodiments, receiving an activation input for a commodity at block 10 may include detecting access to a commodity, such as, for example, by detecting opening and/or accessing a container storing the commodity.

In some embodiments, receiving an activation input for a commodity at block 10 may include receiving a message that a request for access to a commodity has been identified and/or detected. For example, the message may indicate that a passcode enabling access to the commodity was obtained.

Referring again to FIG. 1, upon receiving an activation input at block 10, the method may include providing access to the commodity at block 40. Access may be provided to a user, such as, for example, by providing the user with a passcode, by remotely activating and/or providing access to the commodity, and/or by unlocking a container storing the commodity. Some embodiments include, responsive to receiving the activation input for the commodity at block 10, validating the activation input to determine authorized access to the commodity at block 30 and, responsive to validating the activation input, providing the user access to the commodity at block 40. Validating the activation input at block 30 may include identifying the user, such as, for example, by the user's driver's license number, social security number, employee number, and/or the like, and confirming that the user is authorized to access the commodity. In some embodiments, validating the activation input at block 30 may include confirming that the user has an identification (e.g., a passcode, contract number, vehicle identification number, etc.) that indicates that the user is authorized to access the commodity.

The information relating to the activation input for the commodity may be stored at block 50 to preserve the information for subsequent access and/or use. In some embodiments, a third party and/or a retailer (e.g., a rental company) may access and/or use the information in order to manage the commodity. Some embodiments include transmitting the information relating to the activation input for the commodity at block 60 to track access to the commodity. The information may be transmitted to a party charged with managing the commodity, such as, for example, a rental company.

Managing the commodity may involve tracking access to the commodity, such as the date, time, and/or frequency of access. Access to the commodity may be tracked over a period of time, such as, for example, hour(s), day(s), week(s), month(s), and/or year(s). In some embodiments, the period of time may be based on a period of time a user has access to a commodity, such as, the period of time set forth in a rental agreement and/or an employee agreement. In some embodiments, access to a commodity may be tracked based on a single user and/or contract (e.g., rental agreement) associated with the commodity. In some embodiments, access to a commodity may be tracked based on multiple users and/or contracts. Managing the commodity may include accessing and reviewing the information relating to the activation input for a commodity to determine and/or identify any actions in regard to the commodity (e.g., inspecting, replacing, refilling, cleaning, charging, etc.).

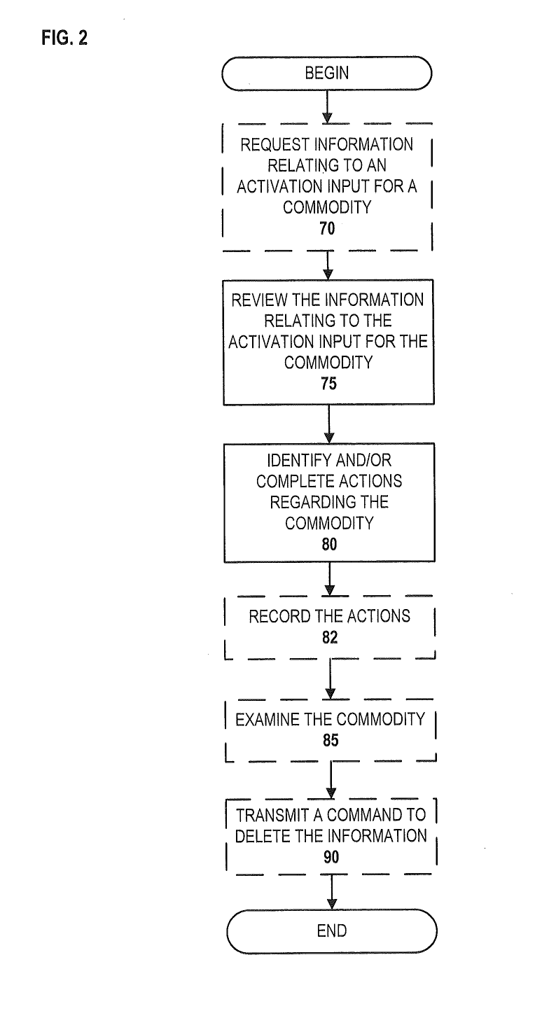

Reference is now made to FIG. 2, which is a flowchart illustrating operations of a party receiving information according to some embodiments of the present inventive subject matter. A party, such as a party that manages the commodity (e.g., a rental company), may review the information relating to the activation input for the commodity at block 75. In some embodiments, the party may have access to the information, such as, for example, physical access to where the information is stored. In some embodiments, the party may need to request the information relating to the activation input for a commodity at block 70, such as, for example, from a server. The party may request the information at block 70 and may upload and/or save the information to their database.

In some embodiments, reviewing the information at block 75 may include the party detecting and/or identifying a code configured to demonstrate access to a commodity. The code may indicate actual access to the commodity and/or may indicate the ability to access the commodity, such as by the obtainment of a passcode for accessing the commodity. In some embodiments, the code may be configured to demonstrate access to a passcode for accessing the commodity. For example, the code may be concealed and may include a passcode and/or may be the passcode for accessing a commodity. Thus, to access a commodity, a user may need to remove the concealment to obtain the passcode for accessing the commodity and in doing so may reveal the code. In some embodiments, a concealed code may be provided on a document (e.g., a rental contract, scratch card, etc.) such as a document a user has access to. If the party detects the code, then the information may be entered into their database,

Responsive to reviewing the information relating to the activation input for the commodity at block 75, the party may identify and/or complete any actions in regard to the commodity at block 80, such as, for example, inspecting, replacing, refilling, cleaning, and/or charging the commodity and/or billing the user. The party may record any actions regarding the commodity in their database at block 82. For example, the party may record at block 82 actions needed and/or their completion (e.g., that a replacement commodity is needed and/or that the replacement has been received). Recording the actions at block 82 may aid in managing the commodity.

The party may examine the commodity at block 85. In some embodiments, the party may examine the commodity at block 85 in response to identifying and/or completing actions in regard to the commodity at block 80 and/or the party may examine the commodity at block 85 to determine and/or confirm actions in regard to the commodity. In some embodiments, no activation input may have been received in regard to the commodity, and no information may have been generated and/or available for review.

In some embodiments, the party may transmit a command to delete the information relating to the activation input for the commodity at block 90. In some embodiments, after review of the information, the information may no longer be needed and thus may be deleted. Some embodiments provide that the information may be stored for a period of time, such as, for example, to determine usage of the commodity over an extended period of time, such as a day, week, month, year, or more. In some embodiments, the information may be deleted after a single user is finished with the commodity and/or after a transaction (e.g., a rental transaction) is completed. In some embodiments, the information may be deleted after multiple users are done with the commodity and/or after multiple transactions have been completed. In some embodiments, the command to delete the information at block 90 may be automatically transmitted. The command may be automatically transmitted once the party has indicated that their review of the information is complete. In some embodiments, the command to delete the information at block 90 may be sent after a predetermined period of time, such as, but not limited to, about 1 day, 3 days, 1 week, 1 month, etc., has passed.

After one or more steps and/or operations in FIG. 2, such as, for example, reviewing the information at block 75, identifying and/or completing actions at block 80, and/or examining the commodity at block 85, the commodity may be ready for use by another user. In some embodiments, when a commodity is returned to a party, such as, for example, a rental company, the party may perform one or more steps and/or operations in FIG. 2. In some embodiments, a vehicle containing the commodity may be returned to a party by a user and the party may perform one or more steps and/or operations described in regard to FIG. 2. Upon completion of one or more steps and/or operations in FIG. 2, the party may indicate that the commodity and/or vehicle is ready for use and/or may release (e.g., rent, loan) the commodity and/or vehicle to another user.

In some embodiments, the party may have a check-in and/or check-out procedure in regard to the commodity that may include one or more steps and/or operations in FIG. 2. For example, when the commodity is a vehicle accessory, upon a user returning the vehicle, the party may request and/or review the information relating to an activation input for the commodity and may take any actions to make the commodity ready for use by another user and/or for supplying the commodity in a vehicle to be rented by another user. In some embodiments, the party may visually inspect the commodity to obtain and/or review the information relating to the activation input for the commodity. In some embodiments, the information relating to the activation input for the commodity may be stored on an electronic device the party has access to and when the commodity is checked-in by a user, the party can access and/or review the information on the electronic device, such as, for example, a computer, tablet, and/or mobile terminal, and identify if any actions are needed in regard to the commodity. In some embodiments, the party may use a scanner to request and/or review the information relating to an activation input for the commodity. In some embodiments, upon reviewing the information relating to the activation input for the commodity and/or taking any actions in regard to the commodity (e.g., replacing, refilling, cleaning, and/or charging) to prepare the commodity for use by another user, the party may release the commodity to another user. The process may be repeated once the commodity is again returned.

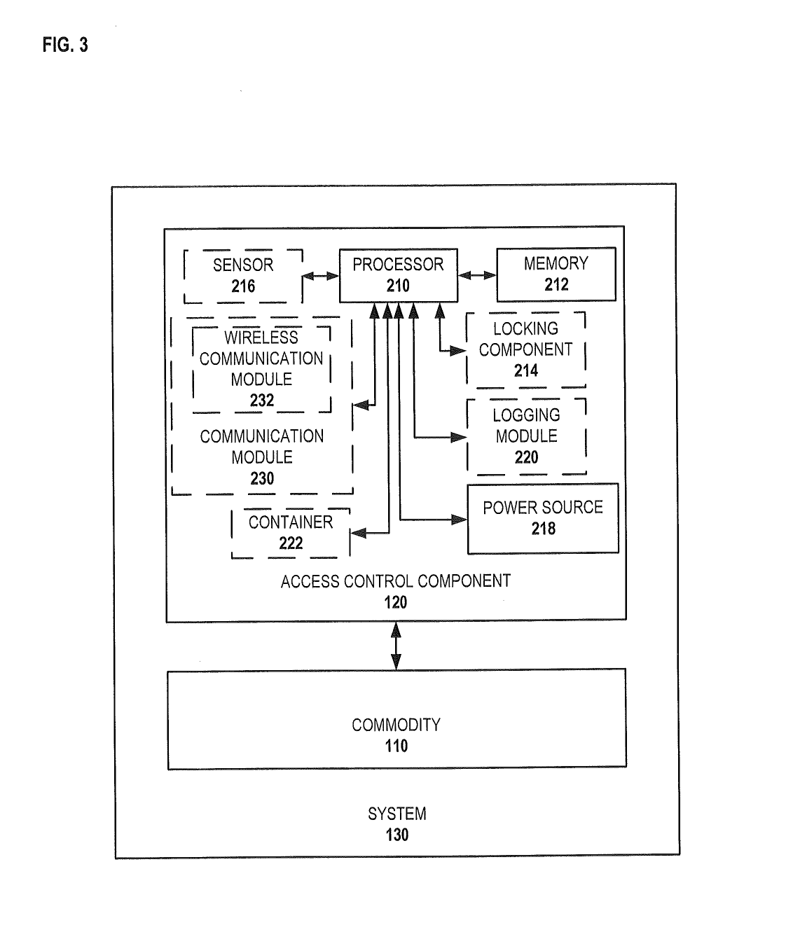

Reference is now made to FIG. 3, which is a block diagram illustrating a system 130 according to some embodiments of the present inventive subject matter. The system 130 may include a commodity 110 and an access control component 120 configured to control access to a commodity 110. The commodity 110 may be associated with the access control component 120. In some embodiments, the access control component 120 may be configured to prevent unauthorized access to the commodity 110 and to provide access to the commodity 110 to an authorized user. The access control component 120 may be associated with, store, and/or attached on, in, and/or to the commodity 110.

The access control component 120 may include a processor 210, a power source 218, a memory 212, optionally a sensor 216, optionally a locking component 214, optionally a logging module 220, optionally a container 222, and optionally a communication module 230 that optionally includes a wireless communication module 232.

The processor 210 may be configured to execute computer program code from memory 212, described below as a computer readable storage medium, to perform at least some of the operations and methods described herein, and may be any conventional processor (s), including, but not limited to the AMD Athlon™ 64, or Intel® Core™ Duo, among others. The memory 212 may be coupled to the processor 210 and may include computer readable program code embodied therein that, when executed by the processor 210, may cause the processor 210 to receive, generate, store, and/or transmit information relating to an activation input for a commodity 110 and/or provide access to a commodity 110.

In some embodiments, an activation input for a commodity 110 may be received at the access control component 120 and/or information relating to the activation input for the commodity 110 may be generated at the access control component 120.

In some embodiments, the access control component 120 may include a locking component 214 configured to prevent unauthorized access to the commodity 110. The locking component 214 may be digital and/or mechanical. In some embodiments, two or more locking components 214 may be provided that may be the same and/or different. Receiving the activation input for the commodity 110 may include receiving a message that an unlocking component configured to unlock the locking component 214 is being and/or has been used at the locking component 214.

The access control component 120, according to some embodiments, may include a container 222 that is configured to store the commodity 110. The container 222 may be of any shape and/or size and may take the form of a box, bag, and/or enclosure. In some embodiments, the container 222 may be a compartment within a vehicle and/or the container 222 may be attached to a vehicle by any method, such as, for example, by metal chain, glue, bolt(s), high power magnet(s), etc. In some embodiments, the container 222 may be stored within a vehicle and of sufficient size to store the commodity 110. In certain embodiments, the container 222 may store two or more, such as 3, 4, 5, 6, 7, or more commodities 110 and/or may include two or more separate compartments. Each of the two or more separate compartments within the container 222 may store at least one commodity 110. In some embodiments, a user may unlock and/or open one compartment of the container 222 to access a desired commodity 110.

In some embodiments, the commodity 110 may not be included in a container 222. In some embodiments, the commodity 110 may be directly attached to a vehicle by any method, such as, for example, by metal chain, glue, bolt(s), high power magnet(s), etc. In some embodiments, the commodity 110 may not be included in a container 222 and the access control component 120 may include a locking component 214 configured to prevent unauthorized access to the commodity 110.

A sensor 216 configured to detect access to the commodity 110 may be included with and/or in the access control component 120. In some embodiments, the sensor 216 may be included in a container 222 of the access control component 120. In some embodiments, the sensor 216 may detect when the container 222 is accessed and/or opened. In some embodiments, the sensor 216 may detect when the commodity 110 is removed from the container 222.

Alternatively or in addition, the container 222 may include a locking component 214 configured to prevent unauthorized access to the commodity 110.

The access control component 120 may include a logging module 220 configured to log the information relating to the activation input for the commodity 110. The logging module 220 may record the date and/or time the activation input was received and/or the date and/or time the commodity 110 and/or access control component 120 was accessed. In some embodiments, the logging module 220 may generate and log the information relating to the activation input for the commodity 110.

In some embodiments, the access control component 120 may include the logging module 220 and the locking component 214, and the logging module 220 may generate and/or log the information relating to the activation input for the commodity 110 when the locking component 214 is unlocked. In some embodiments, receiving the activation input for the commodity 110 may include receiving, at the locking component 214, a message that an unlocking component configured to unlock the locking component 214 is being and/or has been used at the locking component 214 and, responsive to receiving the message, the logging module 220 may generate and/or log information relating to the activation input for the commodity 110.

In some embodiments, the access control component 120 may include the logging module 220 and the container 222, and the logging module 220 may generate and/or log the information relating to the activation input for the commodity 110 when the container 222 is accessed (e.g., opened). In some embodiments, receiving the activation input for the commodity 110 may include detecting, at the sensor 216 included in the access control component 120 and/or container 222, access to the commodity 110 and, responsive to detecting the access, the logging module 220 may generate and/or log information relating to the activation input for the commodity 110.

The information relating to the activation input for the commodity 110 may be stored in logging system 220 and/or in memory 212 of the access control component 120.

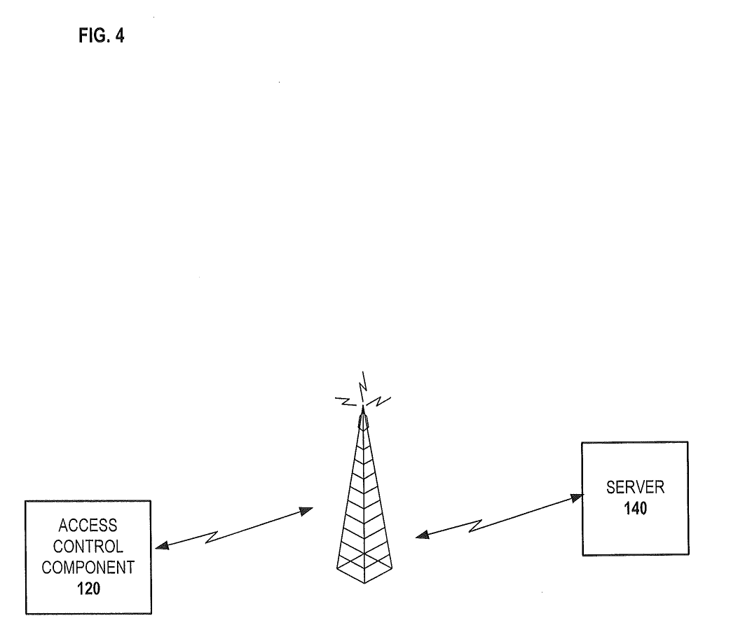

Reference is now made to FIG. 4, which is a schematic diagram illustrating a wireless communications system according to some embodiments of the present inventive subject matter. In some embodiments, the access control component 120 may transmit the information relating to the activation input for the commodity 110 to a server 140. The server 140 may be controlled by a party managing the commodity (e.g., a rental company) and/or by a third party (e.g., a call center) who may provide the information relating to the activation input for the commodity 110 to the party managing the commodity. Referring again to FIG. 2, the access control component 120 may transmit the information using a communication module 230.

The communication module 230 may be operatively coupled to the processor 210 and may operate under the control of the processor 210. The communication module 230 may include a wireless communication module 232. The wireless communication module 232 may provide communication according to a long range communication protocol, such as, but not limited to a cellular communication protocol and/or a short range communication protocol, such as, but not limited to, a non-cellular communication protocol (e.g., Wifi, Bluetooth, etc.).

The communication module 230 may include transmitter and/or receiver circuits, which may cooperate to transmit and/or receive wireless communication signals. According to various embodiments, the communication module 230 of the access control component 110 may be configured to operate in any of the following bands: Advanced Mobile Phone Service (AMPS), ANSI-136, Global System for Mobile Communications (GSM), Third Generation Partnership Project (3GPP) Long Term Evolution (LTE), General Packet Radio Service (GPRS), enhanced data rates for GSM evolution (EDGE), Digital Communications Services (DCS), Personal Digital Cellular (PDC), Personal Communications Services (PCS), Code Division Multiple Access (CDMA), wideband-CDMA, CDMA2000, and/or Universal Mobile Telecommunications System (UMTS) frequency bands. Other bands can also be used in embodiments according to the inventive concepts. Also, various embodiments may be compatible with Long Term Evolution (LTE) and/or High Speed Packet Access (HSPA) standards.

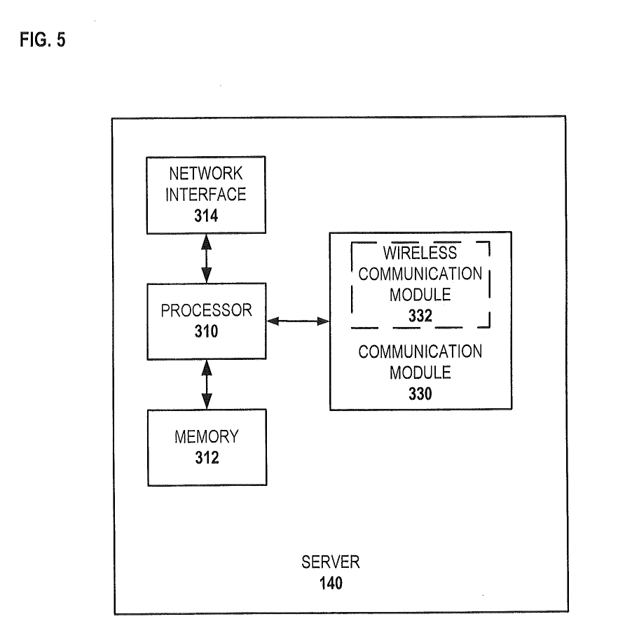

Reference is now made to FIG. 5, which is a block diagram illustrating a server 140 according to some embodiments of the present inventive subject matter. The server 140 may include a processor 310, a memory 312, a network interface 314, and a communication module 330 that may include a wireless communication module 332. Certain components of server 140 have been described above in regard to FIG. 3 and duplicate discussion thereof may be omitted herein for the purpose of discussing FIG. 5. The processor 310 may be configured to generate information relating an activation input for a commodity 110. The communication module 330 and/or wireless communication module 332 may be configured to receive an activation input for a commodity 110 and/or to transmit the information relating to the activation input for the commodity. The memory 312 may be configured to store computer related instructions that, when executed, cause the processor to generate the information relating to the activation input for the removable commodity and to store the information.

The server 140 may include one or more electronic computing devices operable to receive, transmit, detect, process, and/or store data. For example, the server 140 may include one or more general-purpose personal computers, workstations, server computers, server pools, or any other suitable devices. In some embodiments, the server 140 may include a web server and may include any suitable combination of software, firmware, and hardware. In some embodiments, the server 140 may be a third party server that is remotely located from the commodity 110.

The server 140 may be communicatively coupled via a network interface 314. The network interface 314 may facilitate wireless and/or wireline communication, and may communicate using, for example, IP packets, Frame Relay frames, Asynchronous Transfer Mode (ATM) cells, voice, video, data, and other suitable information between network addresses. The network interface 314 may include one or more local area networks (LANs), radio access networks (RANs), metropolitan area networks (MANs), wide area networks (WANs), all or a portion of the global computer network known as the Internet, and/or any other communication system or systems at one or more locations. Although referred to herein as a “server”, it will be appreciated that any suitable computing device may be used. A network address may include an alphabetic and/or numerical label assigned to a device in a network. For example, a network address may include an IP address, an IPX address, a network layer address, a MAC address, an X.25/X.21 address, and/or a mount point in a distributed file system, among others.

In some embodiments, the server 140 may receive an activation input for a commodity 110 and/or may generate the information relating to the activation input for the commodity 110. For example, a user may request access to a commodity 110 by calling a dedicated phone number associated with the server 140 and/or accessing the server 140 using a mobile device application. The communication module 330 and/or wireless communication module 332 of the server 140 may receive the activation input for the commodity 110 (e.g., the request for access to the commodity 110 from a user). Responsive to receiving the activation input, the processor 310 of the server 140 may generate the information relating to the activation input for the commodity 110. The information may be stored in the memory 312 of the sever 140.

The server 140 may provide access to the commodity 110 to a user. To provide access, the server 140 may use the communication module 330, wireless communication module 332, and/or network interface 314. In some embodiments, the server 140 may provide access to the commodity 110 by providing a passcode and/or by remotely providing access to the commodity 110.

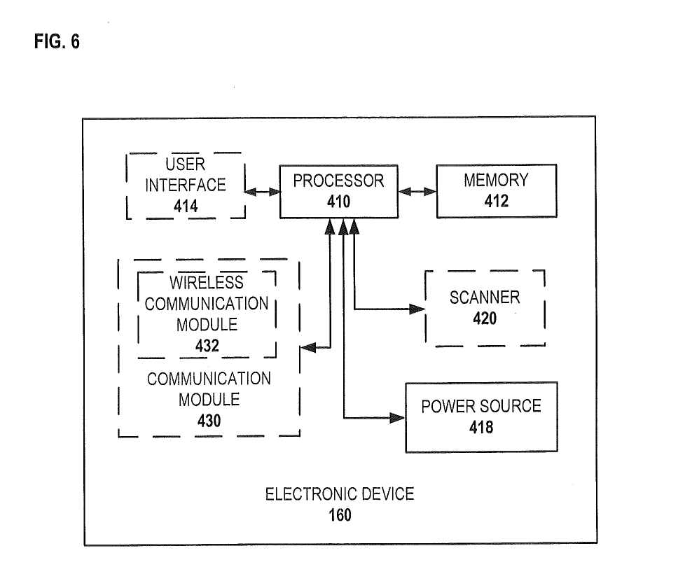

Reference is now made to FIG. 6, which is a block diagram illustrating an electronic device 160 according to some embodiments of the present inventive subject matter. The electronic device 160 may receive the activation input for the commodity 110 and/or may generate the information relating to the activation input for the commodity 110. The electronic device 160 may include a processor 410 coupled to a memory 412 and a power source 418 and may optionally include a user interface 414, a scanner 420, and a communication module 430 that may include a wireless communication module 432. Certain components of the electronic device 160 have been described above in regard to FIG. 3 and duplicate discussion thereof may be omitted herein for the purpose of discussing FIG. 6.

The processor 410 may be configured to generate information relating to an activation input for a commodity 110. In some embodiments, the processor 410 may include a scanner 420, and the scanner 420 may be configured to detect the activation input for the commodity 110. The communication module 430 and/or wireless communication module 432 may be configured to receive an activation input for a commodity and/or to transmit the information relating to the activation input for the commodity 110. The memory 412 may be configured to store the information.

The electronic device 160 may be configured to detect and/or identify a code configured to demonstrate access to a commodity 110. The code may indicate actual access to the commodity 110 and/or may indicate the ability to access the commodity 110, such as by the obtainment of a passcode for accessing the commodity 110. In some embodiments, the code may be configured to demonstrate access to a passcode for accessing the commodity 110. In certain embodiments, the code may be the passcode for accessing the commodity 110 and the electronic device 160 may detect and/or identify the passcode.

In some embodiments, the electronic device 160 may include a scanner 420. The scanner 420 may be configured to detect a code configured to demonstrate access to a commodity 110. In some embodiments, the code may be concealed and the scanner 420 may detect when the concealment has been removed. The code may be, for example, a passcode and/or barcode. In some embodiments, a concealed code may be provided on a document (e.g., a rental contract, scratch card, etc.) such as a document a user has access to, the commodity 110, and/or an access control component 120. The user may remove the concealment, such as, for example, by tearing and/or scratching off the concealment. Once the concealment is removed, the user may then obtain a passcode for accessing the commodity 110 and the scanner 420 may detect that the commodity 110 has been accessed by detecting the code.

Responsive to detecting the code, the electronic device 160 may generate information relating to the activation input, such as, an indication that the commodity 110 has been accessed. For example, the electronic device 160 may generate the information relating to the activation input, which may include a message that confirms that the commodity 110 was accessed. The information may be transmitted using a communication module 430, such as a wireless communication module 432, to another electronic device and/or server that may store the information. In some embodiments, the information may be stored in the memory 412 of the electronic device 160 and may be displayed at a user interface 414 on the electronic device 160. The user interface 414 may display at least a portion of the information relating to the activation input for the commodity 110 and/or an indication that the information relating to the activation input for the commodity 110 was generated.

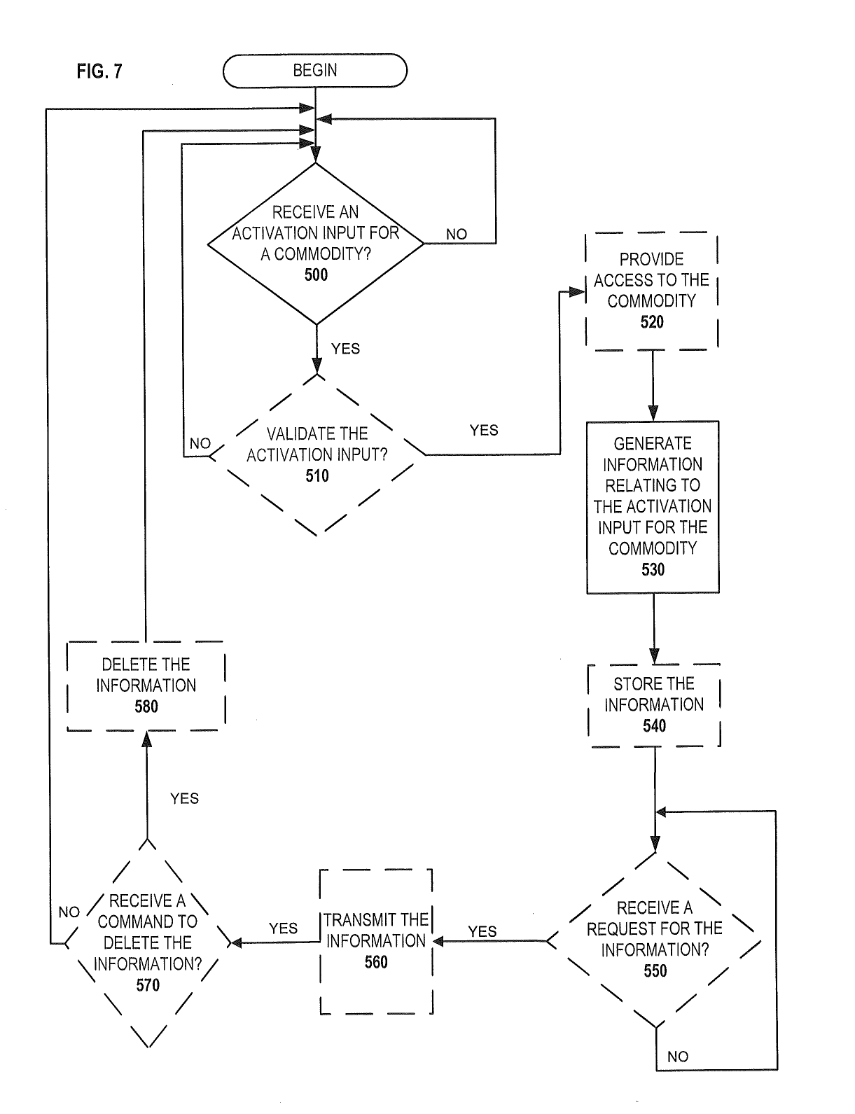

Reference is now made to FIG. 7, which is a flowchart illustrating operations in managing a commodity 110 according to some embodiments of the present inventive subject matter. An access control component 120, server 140, and/or electronic device 160 may determine if an activation input for a commodity 110 has been received at block 500. If no activation input has been received, then no further action may be needed on behalf of the access control component 120, server 140, and/or electronic device 160. The access control component 120, server 140, and/or electronic device 160 may continuously determine if an activation input for a commodity has been received at block 500.

In some embodiments, the access control component 120, server 140, and/or electronic device 160 may be managing (e.g., determining if an activation input has been received, etc.) for a single commodity or may be managing two or more commodities. If the access control component 120, server 140, and/or electronic device 160 is managing two or more commodities, then the access control component 120, server 140, and/or electronic device 160 may receive, transmit, and/or store information in a manner that associates the information with the particular commodity the information is in regard to.

In some embodiments, responsive to receiving an activation input, the access control component 120, server 140, and/or electronic device 160 may validate the activation input at block 510. If the activation input is determined to be valid, such as, for example, the activation input is made by an authorized user and/or the correct passcode was entered to access the commodity 110, then access may be provided to the commodity at block 520. In some embodiments, the access control component 120, server 140, and/or electronic device 160 may provide access to the commodity 110 at block 520. In certain embodiments, the access control component 120 and/or server 140 may receive the activation input from a user and may provide access to the commodity 110 to a user.

Responsive to receiving an activation input for a commodity 110 at block 500, the information relating to the activation input for the commodity 110 may be generated at block 530, and, as described above, the information may be generated in any manner and may include an identification for the commodity 110 (e.g., a unique identification such as a number or code associated with the particular commodity), the date and/or time the activation input was received and/or the commodity 110 was accessed, and/or an indication as to whether the commodity 110 was accessed (e.g., a confirmation message that the commodity was accessed). The access control component 120, server 140, and/or electronic device 160 may generate the information at block 530 and may generate the information simultaneously with one or more of the operations and/or steps described in FIG. 7, such as, for example, simultaneously with receiving the activation input at block 500, and/or at any time after the activation input is received. The information may be stored at block 540, such as by the access control component 120, server 140, and/or electronic device 160. In some embodiments, the information may be stored at block 540 for a predetermined period of time, such as, for example, minute(s), hour(s), day(s), month(s), and/or year(s).

In some embodiments, the access control component 120, server 140, and/or electronic device 160 may transmit the information at block 560. The transmission of the information may be automatic upon generating the information at block 530 and/or may be transmitted after a predetermined period of time. In some embodiments, an access control component 120 may generate the information and may transmit the information to a server 140 and/or electronic device 160. In some embodiments, an electronic device 160 may generate the information and may transmit the information to a server 140.

In some embodiments, the access control component 120, server 140, and/or electronic device 160 may receive a request for the information at 550 block and then may transmit the information at block 560. If no request for the information has been received at block 550, then the access control component 120, server 140, and/or electronic device 160 may continue to store the information as described above in regard to block 540. Alternatively, the information may not be transmitted from the access control component 120, server 140, and/or electronic device 160 and may be accessed by a party, such as a party that manages the commodity 110 (e.g., a rental company), from the access control component 120, server 140, and/or electronic device 160.

The access control component 120, server 140, and/or electronic device 160 may determine if a command to delete the information has been received at block 570. If no command to delete the information has been received at block 570, then the information may remain on the access control component 120, server 140, and/or electronic device 160. If a command to delete the information has been received at block 570, then the information relating to the activation input for the commodity 110 may be deleted at block 580. The information may be deleted at block 580 from the memory of access control component 120, server 140, and/or electronic device 160.

Alternatively or in addition, the information may be deleted at block 580 after a predetermined period of time has passed, such as, but not limited to, about 1 day, 3 days, 1 week, 1 month, etc. In some embodiments, the information may be deleted at block 580 once a time-out command has been received. The time-out command may be automatically sent by the access control component 120, server 140, and/or electronic device 160 after a predetermined period of time has passed, such as, for example, minute(s), hour(s), day(s), month(s), and/or year(s).

During one or more operations and/or steps described in regard to FIG. 7, the access control component 120, server 140, and/or electronic device 160 may be acting at one or more of the same and/or different operations and/or steps relating to the same commodity or a different commodity. In some embodiments, one or more different or the same operations and/or steps may be occurring at any given time.

In some embodiments, the access control component 120, server 140, or electronic device 160 performs each of the operations and/or steps described in regard to FIG. 7. In some embodiments, the access control component 120, server 140, or electronic device 160 performs one or more of the operations and/or steps described in regard to FIG. 7.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Some embodiments provide that one or more of the programs may be executed during a portion of execution of another one of the programs in the corresponding process operation.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
receiving an activation input for a commodity; and
responsive to receiving the activation input, generating information relating to the activation input for the commodity.

2. The method of claim 1, wherein receiving the activation input corresponds to a request for access to the commodity by a user and, responsive to receiving the activation input for the commodity, providing the user access to the commodity.

3. The method of claim 2, further comprising:
responsive to receiving the activation input for the commodity, validating the activation input to determine authorized access to the commodity; and
responsive to validating the activation input, providing the user access to the commodity.

4. The method of claim 1, further comprising storing the information relating to the activation input for the commodity to preserve the information for subsequent access and/or use.

5. The method of claim 4, further comprising transmitting the information relating to the activation input for the commodity to track access to the commodity.

6. The method of claim 1, wherein receiving the activation input for the commodity and/or generating the information relating to the activation input for the commodity comprises receiving, at an access control component of the commodity, the activation input for the commodity and/or generating, at the access control component of the commodity, the information relating to the activation input for the commodity.

7. The method of claim 6, wherein the access control component includes a locking component that is configured to prevent unauthorized access to the commodity.

8. The method of claim 7, wherein receiving the activation input for the commodity comprises receiving a message that an unlocking component that is configured to unlock the locking component is being and/or has been used at the locking component.

9. The method of claim 6, wherein the access control component includes a container that is configured to store the commodity.

10. The method of claim 9, further comprising detecting access to the commodity using a sensor that is configured to detect access to the commodity stored in the container.

11. The method of claim 6, further comprising logging the information generated relating to the activation input for the commodity in a logging module in the access control component.

12. The method of claim 11, wherein receiving the activation input for the commodity comprises receiving, at a locking component included in the access control component, a message that an unlocking component that is configured to unlock the locking component is being and/or has been used at the locking component and wherein, responsive to receiving the message, generating the information relating to the activation input for the commodity at the logging module.

13. The method of claim 11, wherein receiving the activation input for the commodity comprises detecting, at a sensor included in the access control component, access to the commodity and, responsive to detecting the access, generating the information relating to the activation input for the commodity at the logging module.

14. The method of claim 1, wherein receiving the activation input for the commodity and/or generating the information relating to the activation input for the commodity comprises receiving at a server the activation input for the commodity and/or generating at the server the information relating to the activation input for the commodity.

15. The method of claim 14, wherein receiving the activation input for the commodity comprises receiving at the server a request for access to the commodity from a user and, responsive to receiving the activation input, generating at the server the information relating to the activation input for the commodity and providing the user access to the commodity.

16. The method of claim 1, wherein receiving the activation input for the commodity comprises receiving, at an electronic device, a code that is configured to demonstrate access to the commodity, and wherein the code is configured to demonstrate access to a passcode for accessing the commodity.

17. The method of claim 1, further comprising:
accessing the information relating to the activation input for the commodity; and
responsive to accessing the information relating to the activation input for the commodity, inspecting the commodity.

18. The method of claim 1, further comprising:
reviewing the information relating to the activation input for the commodity; and
providing the commodity to a second user.

19. A system comprising:
a commodity;
an access control component that is configured to prevent unauthorized access to the commodity and to provide access to the commodity to an authorized user; and
a communication module that is configured to send and/or receive information relating to an activation input for the commodity that, upon receipt thereof, causes the access control component to provide access to the commodity to the authorized user.

20. A server comprising:
a processor that is configured to generate information relating an activation input for a commodity;
a communication module that is configured to receive an activation input for a commodity and to transmit the information relating to an activation input for the commodity; and
a memory that is configured to store computer related instructions that, when executed, cause the processor to generate the information relating to the activation input for the commodity and to store the information.

21. An electronic device comprising:
a processor that is configured to generate information relating to an activation input for a commodity, the processor comprising a scanner that is configured to detect the activation input for the commodity;
a communication module that is configured to transmit the information relating to the activation input for the commodity; and
a memory that is configured to store computer related instructions that, when executed, cause the processor to generate the information relating to the activation input for the commodity and to store the information.

22. The electronic device of claim 21, further comprising a user interface that is configured to display at least a portion of the information relating to the activation input for the removable commodity and/or an indication that the information relating to the activation input for the removable commodity was generated.
